(19) United States
(12) Patent Application Publication
(10) Pub. No.: US 2025/0367813 A1
(43) Pub. Date: Dec. 4, 2025

(54) GRIP ASSEMBLY

(71) Applicant: Maan-Jyi Chang, Taichung City (TW)

(72) Inventor: Maan-Jyi Chang, Taichung City (TW)

(21) Appl. No.: 18/675,673

(22) Filed: May 28, 2024

(51) Int. Cl. B25G 1/10; B25G 1/06; B25G 3/20

(52) U.S. Cl. CPC B25G 1/102; B25G 1/063; B25G 3/20

(57) ABSTRACT

A grip assembly includes an upper control module, a connecting member connected with the upper control module, and a lower control unit connected with the connecting member. The lower control unit is arranged opposite to the upper control module. The upper control module includes an upper control member, multiple upper locking members, multiple upper springs, multiple upper retaining members, an upper mounting member, an upper coupling member, and an upper elastic member mounted in the upper mounting member. The lower control module includes a lower control member, multiple lower locking members, multiple lower retaining members, a lower mounting member, a lower coupling member, and a lower elastic member. Thus, the grip assembly that allows a user's holding and allows a quick rotation of a T-shaped wrench.

### BACKGROUND OF THE INVENTION

### Field of the Invention

The present invention relates to a grip (or handle) assembly and, more particularly, to a grip assembly for a T-shaped wrench.

### Description of the Related Art

A conventional T-shaped wrench 90 in accordance with the prior art shown in FIG. 16 comprises a handle section 91, a shank 92, and a mounting portion 93. The shank 92 has a first end provided with the handle section 91 and a second end provided with the mounting portion 93. The mounting portion 93 is mounted on a screwdriver tip. Thus, the handle section 91 is driven by a user to rotate the shank 92 which rotates the mounting portion 93 to rotate the screwdriver tip. However, when the user's one hand holds the handle section 91 to rotate the screwdriver tip, the outer peripheral face of the shank 92 is held by the user's other hand, so that a friction produces between the user's other hand and the outer peripheral face of the shank 92. Thus, the T-shaped wrench 90 is not rotated smoothly. In addition, the handle section 91 cannot rotate the screwdriver tip quickly.

### BRIEF SUMMARY OF THE INVENTION

The primary objective of the present invention is to provide a grip assembly that allows a user's holding and allows a quick rotation of a T-shaped wrench.

The secondary objective of the present invention is to provide a grip assembly that is freely moved upward and downward on the shank of the T-shaped wrench and is positioned on the shank of the T-shaped wrench in a stepless manner.

In accordance with the present invention, there is provided a grip assembly comprising an upper control module, a connecting member connected with the upper control module, and a lower control unit connected with the connecting member. The lower control unit is arranged opposite to the upper control module. The upper control module includes an upper control member provided with multiple upper ball holes and multiple upper receiving holes, multiple upper locking members mounted in the upper ball holes, multiple upper springs mounted in the upper receiving holes, multiple upper retaining members mounted in the upper receiving holes, an upper mounting member mounted on the upper control member, an upper coupling member mounted on the upper control member, and an upper elastic member mounted in the upper mounting member. The upper control member has a tubular shape. The upper control member has a first end provided with an upper coupling portion and a second end provided with an upper end portion having a larger diameter. The upper receiving holes are formed in the upper end portion. The upper mounting member has a cylindrical shape and allows a user's hand holding. The upper mounting member has an interior provided with an upper receiving portion mounted on the upper control member. The upper receiving portion has a first end provided with an upper conic face and a second end provided with an upper internal threaded section. The connecting member has a first end provided with an upper external threaded section and a second end provided with a lower external threaded section. The upper internal threaded section of the upper mounting member is screwed onto the upper external threaded section of the connecting member. The lower control module includes a lower control member provided with multiple lower ball holes and multiple lower receiving holes, multiple lower locking members mounted in the lower ball holes, multiple lower springs mounted in the lower receiving holes, multiple lower retaining members mounted in the lower receiving holes, a lower mounting member mounted on the lower control member, a lower coupling member mounted on the lower control member, and a lower elastic member mounted in the lower mounting member. The lower control member has a tubular shape. The lower control member has a first end provided with a lower coupling portion and a second end provided with a lower end portion having a larger diameter. The lower receiving holes are formed in the lower end portion. The lower mounting member has a cylindrical shape and allows the user's hand holding. The lower mounting member has an interior provided with a lower receiving portion mounted on the lower control member. The lower receiving portion has a first end provided with a lower conic face and a second end provided with a lower internal threaded section. The lower internal threaded section of the lower mounting member is screwed onto the lower external threaded section of the connecting member.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a grip assembly in accordance with the preferred embodiment of the present invention.

FIG. 2 is an exploded perspective view of the grip assembly in accordance with the preferred embodiment of the present invention.

FIG. 3 is a cross-sectional view of an upper mounting member of the grip assembly in accordance with the preferred embodiment of the present invention.

FIG. 4 is a cross-sectional view of a lower mounting member of the grip assembly in accordance with the preferred embodiment of the present invention.

FIG. 5 is a cross-sectional view of the grip assembly in accordance with the preferred embodiment of the present invention.

FIG. 6 is an exploded perspective view of the grip assembly and a T-shaped wrench in accordance with the preferred embodiment of the present invention.

FIG. 7 is a perspective view of the grip assembly and the T-shaped wrench in accordance with the preferred embodiment of the present invention.

FIG. 8 is a cross-sectional view of the grip assembly and the T-shaped wrench in accordance with the preferred embodiment of the present invention.

FIG. 9 is a schematic operational view of the grip assembly as shown in FIG. 8.

FIG. 10 is a schematic operational view of the grip assembly as shown in FIG. 9.

FIG. 11 is a schematic operational view of the grip assembly as shown in FIG. 8.

FIG. 12 is a schematic operational view of the grip assembly as shown in FIG. 11.

FIG. 13 is a cross-sectional view of the grip assembly and the T-shaped wrench in accordance with another preferred embodiment of the present invention.

FIG. 14 is a cross-sectional view of the grip assembly and the T-shaped wrench in accordance with a further preferred embodiment of the present invention.

FIG. 15 is a cross-sectional view of the grip assembly and the T-shaped wrench in accordance with a further preferred embodiment of the present invention.

FIG. 16 is a perspective view of a conventional T-shaped wrench in accordance with the prior art.

### DETAILED DESCRIPTION OF THE INVENTION

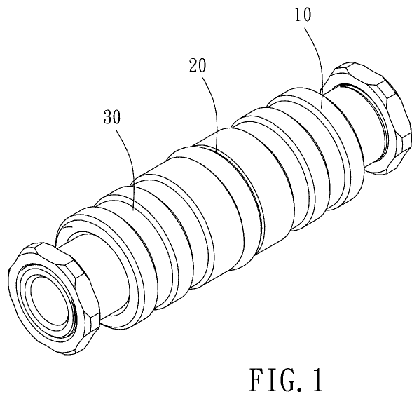

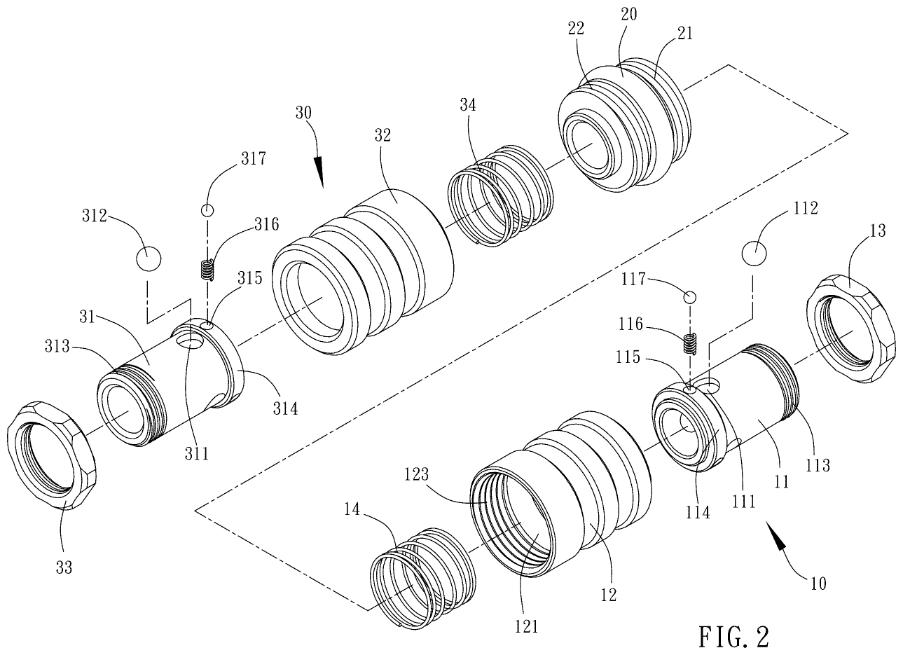

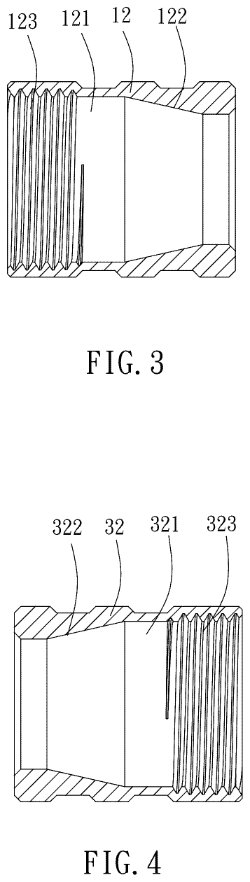

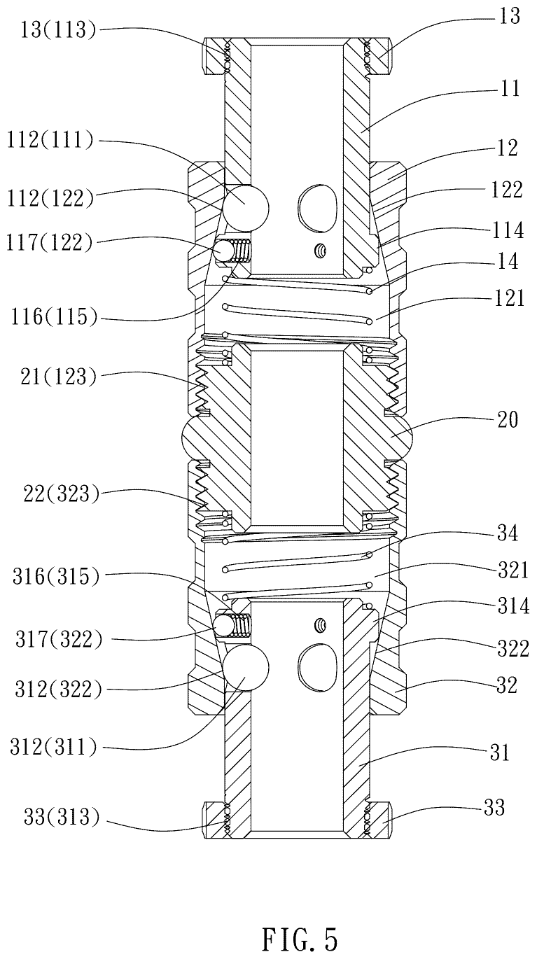

Referring to the drawings and initially to FIGS. 1-5, a grip assembly in accordance with the preferred embodiment of the present invention comprises an upper control module 10, a connecting member 20 connected with the upper control module 10, and a lower control unit 30 connected with the connecting member 20. The lower control unit 30 is arranged opposite to the upper control module 10.

The upper control module 10 includes an upper control member 11 provided with multiple upper ball holes 111 and multiple upper receiving holes 115, multiple upper locking members 112 mounted in the upper ball holes 111, multiple upper springs 116 mounted in the upper receiving holes 115, multiple upper retaining members 117 mounted in the upper receiving holes 115, an upper mounting member 12 mounted on the upper control member 11, an upper coupling (or fastening) member 13 mounted on the upper control member 11, and an upper elastic member 14 mounted in the upper mounting member 12.

The upper control member 11 has a tubular shape. The upper control member 11 has a first end provided with an upper coupling (or fastening) portion 113 and a second end provided with an upper end portion 114 having a larger diameter. The upper receiving holes 115 are formed in the upper end portion 114. The upper mounting member 12 has a cylindrical shape and allows a user's hand holding. The upper mounting member 12 has an interior provided with an upper receiving portion 121 mounted on the upper control member 11. The upper receiving portion 121 has a first end provided with an upper conic face 122 and a second end provided with an upper internal threaded section 123. The upper elastic member 14 is mounted in the upper receiving portion 121 of the upper mounting member 12 and biased between the upper control member 11 and the connecting member 20.

The connecting member 20 has a first end provided with an upper external threaded section 21 and a second end provided with a lower external threaded section 22. The upper internal threaded section 123 of the upper mounting member 12 is screwed onto the upper external threaded section 21 of the connecting member 20.

The lower control module 30 includes a lower control member 31 provided with multiple lower ball holes 311 and multiple lower receiving holes 315, multiple lower locking members 312 mounted in the lower ball holes 311, multiple lower springs 316 mounted in the lower receiving holes 315, multiple lower retaining members 317 mounted in the lower receiving holes 315, a lower mounting member 32 mounted on the lower control member 31, a lower coupling (or fastening) member 33 mounted on the lower control member 31, and a lower elastic member 34 mounted in the lower mounting member 32.

The lower control member 31 has a tubular shape. The lower control member 31 has a first end provided with a lower coupling (or fastening) portion 313 and a second end provided with a lower end portion 314 having a larger diameter. The lower receiving holes 315 are formed in the lower end portion 314. The lower mounting member 32 has a cylindrical shape and allows the user's hand holding. The lower mounting member 32 has an interior provided with a lower receiving portion 321 mounted on the lower control member 31. The lower receiving portion 321 has a first end provided with a lower conic face 322 and a second end provided with a lower internal threaded section 323. The lower elastic member 34 is mounted in the lower receiving portion 321 of the lower mounting member 32 and biased between the lower control member 31 and the connecting member 20. The lower internal threaded section 323 of the lower mounting member 32 is screwed onto the lower external threaded section 22 of the connecting member 20.

In the preferred embodiment of the present invention, the upper control member 11 is provided with three upper ball holes 111 arranged annularly. Each of the upper ball holes 111 penetrates the upper control member 11, has a tapered shape, and expands outward. Each of the upper locking members 112 is a ball. The upper locking members 112 have a number equal to that of the upper ball holes 111. The upper control module 10 includes three upper locking members 112.

In the preferred embodiment of the present invention, the upper coupling portion 113 of the upper control member 11 is an external thread. The upper coupling member 13 has a circular shape and has an internal thread screwed onto the upper coupling portion 113 of the upper control member 11.

In the preferred embodiment of the present invention, the upper control member 11 is provided with three upper receiving holes 115 arranged annularly.

In the preferred embodiment of the present invention, the upper elastic member 14 has a first end pressing the upper end portion 114 of the upper control member 11 and a second end pressing the connecting member 20.

In the preferred embodiment of the present invention, the lower control member 31 is provided with three lower ball holes 311 arranged annularly. Each of the lower ball holes 311 penetrates the lower control member 31, has a tapered shape, and expands outward. Each of the lower locking members 312 is a ball. The lower locking members 312 have a number equal to that of the lower ball holes 311. The lower control module 30 includes three lower locking members 312.

In the preferred embodiment of the present invention, the lower coupling portion 313 of the lower control member 31 is an external thread. The lower coupling member 33 has a circular shape and has an internal thread screwed onto the lower coupling portion 313 of the lower control member 31.

In the preferred embodiment of the present invention, the lower control member 31 is provided with three lower receiving holes 315 arranged annularly.

In the preferred embodiment of the present invention, the lower elastic member 34 has a first end pressing the lower end portion 314 of the lower control member 31 and a second end pressing the connecting member 20.

In the preferred embodiment of the present invention, the connecting member 20 has a tubular shape.

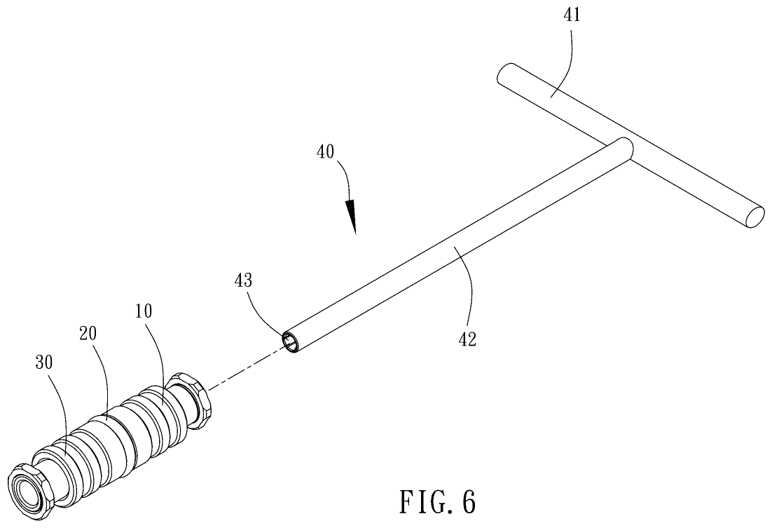

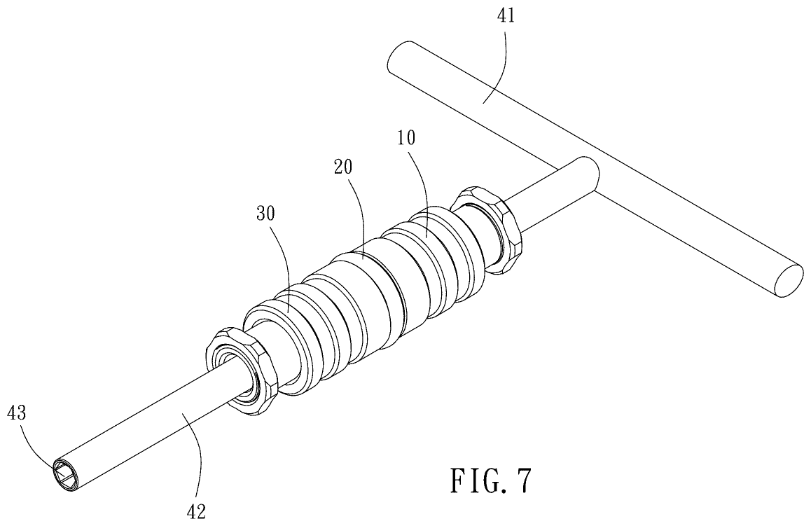

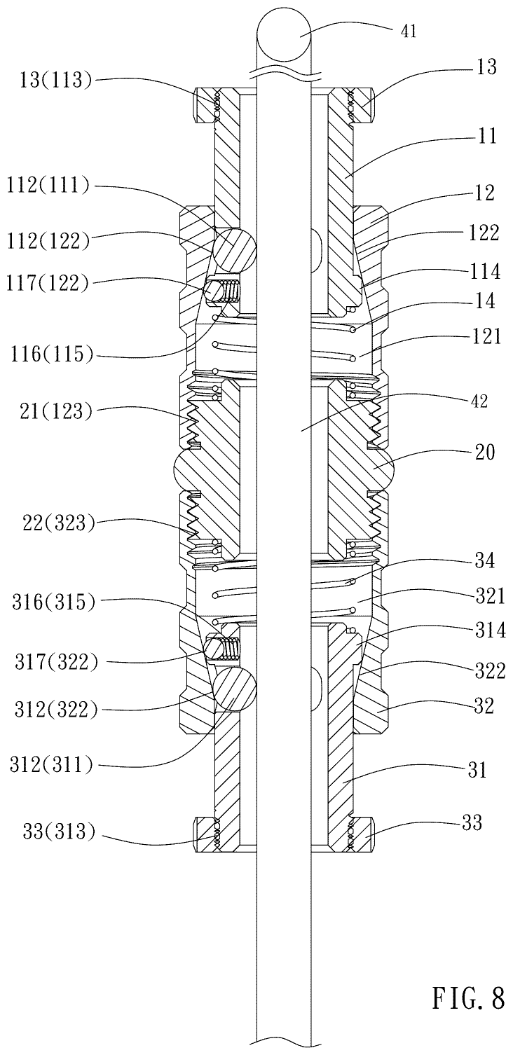

In practice, referring to FIGS. 6-8 with reference to FIGS. 1-5, the grip assembly is mounted on a T-shaped wrench 40 including a handle section 41, a shank 42, and a mounting portion 43. When the upper coupling member 13 of the upper control module 10 is pressed, the upper control member 11 is moved in the upper receiving portion 121 of the upper mounting member 12 toward the connecting member 20, and the upper locking members 112 are also moved with the upper control member 11. At the same time, when the lower coupling member 33 of the lower control module 30 is pressed, the lower control member 31 is moved in the lower receiving portion 321 of the lower mounting member 32 toward the connecting member 20, and the lower locking members 312 are also moved with the lower control member 31. Then, the shank 42 of the T-shaped wrench 40 is inserted through the upper control member 11, the connecting member 20, and the lower control member 31 so that the grip assembly is mounted on the shank 42 of the T-shaped wrench 40. After the upper coupling member 13 is released, the upper control member 11 is returned by the restoring force of the upper elastic member 14, so that the upper locking members 112 are pressed between the upper conic face 122 of the upper mounting member 12 and the shank 42 of the T-shaped wrench 40. At the same time, after the lower coupling member 33 is released, the lower control member 31 is returned by the restoring force of the lower elastic member 34, so that the lower locking members 312 are pressed between the lower conic face 322 of the lower mounting member 32 and the shank 42 of the T-shaped wrench 40. Thus, the upper locking members 112 are pressed and retained by the upper conic face 122 of the upper mounting member 12, and the lower locking members 312 are pressed and retained by the lower conic face 322 of the lower mounting member 32, so that the upper control member 11 and the lower control member 31 are positioned on the shank 42 of the T-shaped wrench 40.

In use, the mounting portion 43 of the T-shaped wrench 40 is mounted on a screwdriver tip. Then, the upper mounting member 12 or the lower mounting member 32 are held by the user's hand, and the mounting portion 43 of the T-shaped wrench 40 is rotated by the user's other hand. At this time, the shank 42 of the T-shaped wrench 40 is limited by the upper locking members 112 and the lower locking members 312, so that the shank 42 (together with the upper control member 11 and the lower control member 31) is rotated in the upper mounting member 12 and the lower mounting member 32. Thus, the grip assembly will not be rotated with the shank 42 of the T-shaped wrench 40 so that the grip assembly provides a quick rotation function to the shank 42 of the T-shaped wrench 40. It is noted that, the shank 42 of the T-shaped wrench 40 is rotated in the upper control member 11 and the lower control member 31.

In addition, the shank 42 of the T-shaped wrench 40 is inserted through the upper control member 11 and the lower control member 31. The upper springs 116 and the upper retaining members 117 are mounted in the upper receiving holes 115 of the upper control member 11, so that the upper retaining members 117 are pushed by the upper springs 116 and presses an inner edge of the upper receiving portion 121 of the upper mounting member 12. The lower springs 316 and the lower retaining members 317 are mounted in the lower receiving holes 315 of the lower control member 31, so that the lower retaining members 317 are pushed by the lower springs 316 and presses an inner edge of the lower receiving portion 321 of the lower mounting member 32. Thus, when the shank 42 of the T-shaped wrench 40 is rotated, the upper control member 11 is pushed and supported by the upper retaining members 117 and is steadily limited in the upper mounting member 12 without shaking or swaying, while lower control member 31 is pushed and supported by the lower retaining members 317 and is steadily limited in the lower mounting member 32 without shaking or swaying.

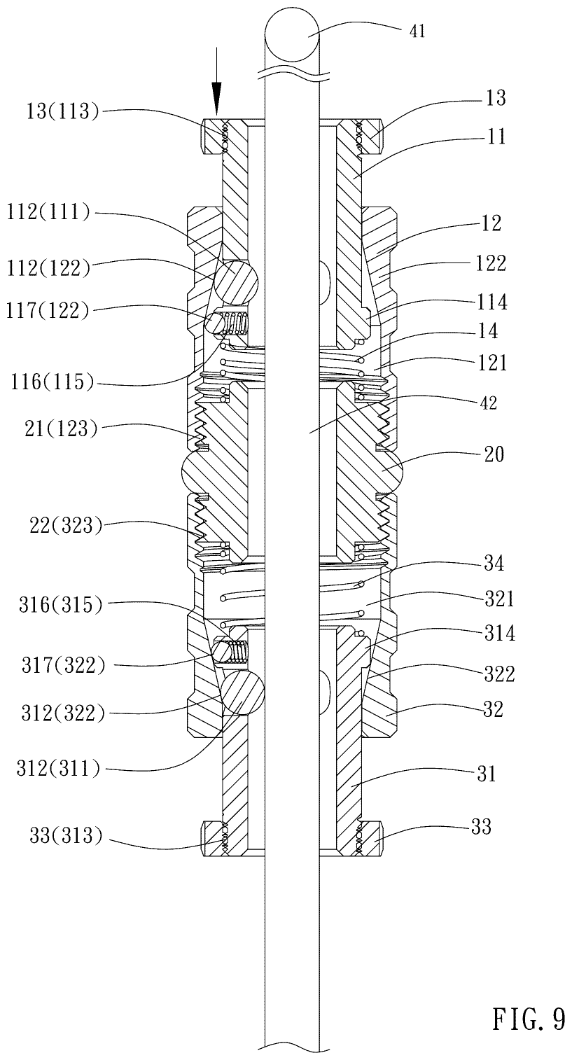

Referring to FIG. 9 with reference to FIGS. 1-8, when the upper coupling member 13 of the upper control module 10 is pressed, the upper control member 11 is moved in the upper receiving portion 121 of the upper mounting member 12 toward the connecting member 20, and the upper locking members 112 are also moved with the upper control member 11, so that the upper locking members 112 are moved downward relative to the upper conic face 122 of the upper mounting member 12 (to change the relative position between the upper locking members 112 and the upper conic face 122) and are detached from the shank 42 of the T-shaped wrench 40. Thus, the grip assembly is freely moved downward on the shank 42 of the T-shaped wrench 40.

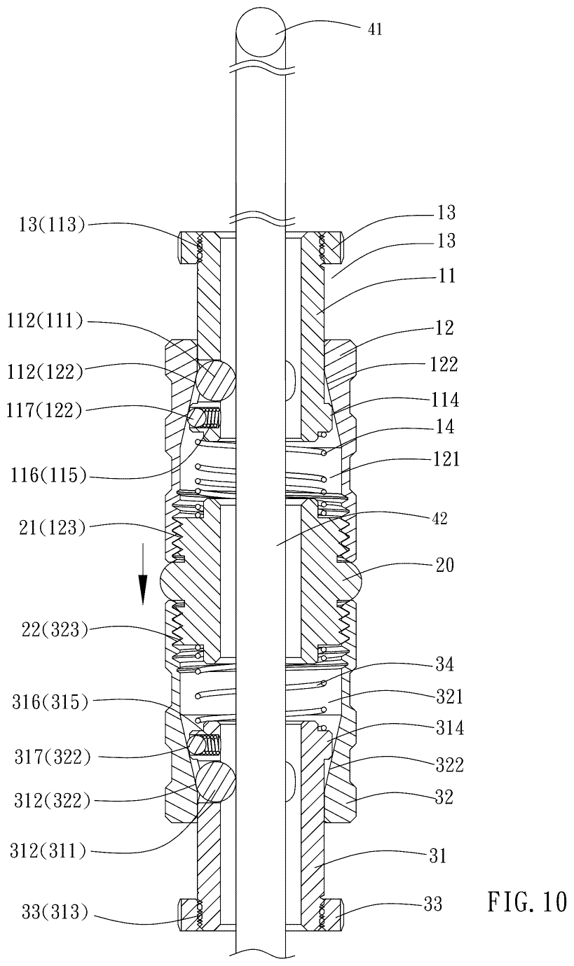

Referring to FIG. 10 with reference to FIG. 9, after the upper coupling member 13 of the upper control module 10 is released, the upper control member 11 is returned by the restoring force of the upper elastic member 14, so that the upper locking members 112 are pressed between the upper conic face 122 of the upper mounting member 12 and the shank 42 of the T-shaped wrench 40, and the grip assembly is positioned on the shank 42 of the T-shaped wrench 40. Thus, the grip assembly is freely moved upward and downward on the shank 42 of the T-shaped wrench 40 so that the position of the grip assembly is adjusted in a stepless manner.

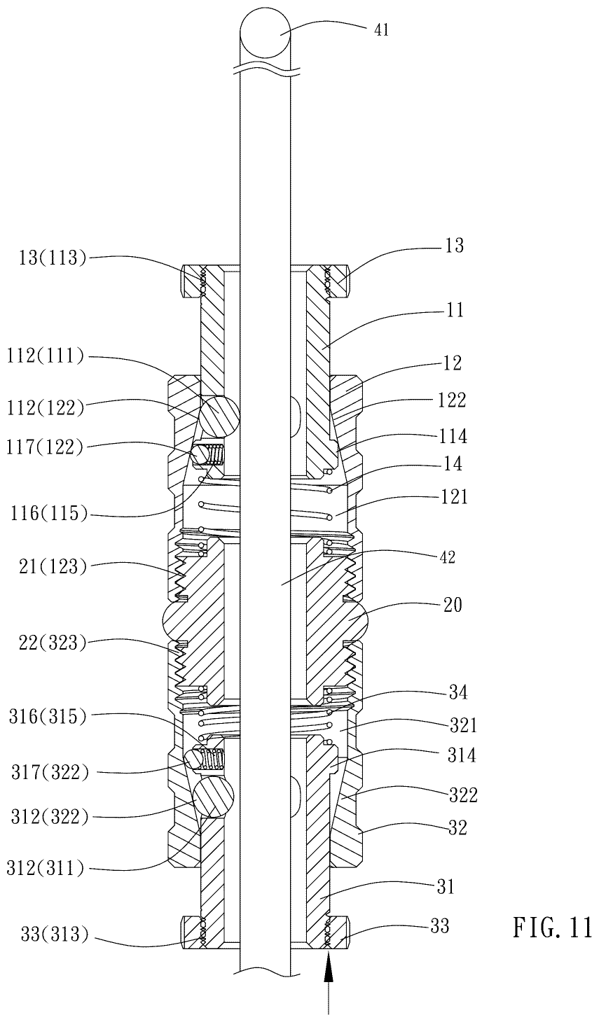

Referring to FIG. 11 with reference to FIGS. 1-8, when the lower coupling member 33 of the lower control module 30 is pressed, the lower control member 31 is moved in the lower receiving portion 321 of the lower mounting member 32 toward the connecting member 20, and the lower locking members 312 are also moved with the lower control member 31, so that the lower locking members 312 are moved upward relative to the lower conic face 322 of the lower mounting member 32 (to change the relative position between the lower locking members 312 and the lower conic face 322) and are detached from the shank 42 of the T-shaped wrench 40. Thus, the grip assembly is freely moved upward on the shank 42 of the T-shaped wrench 40.

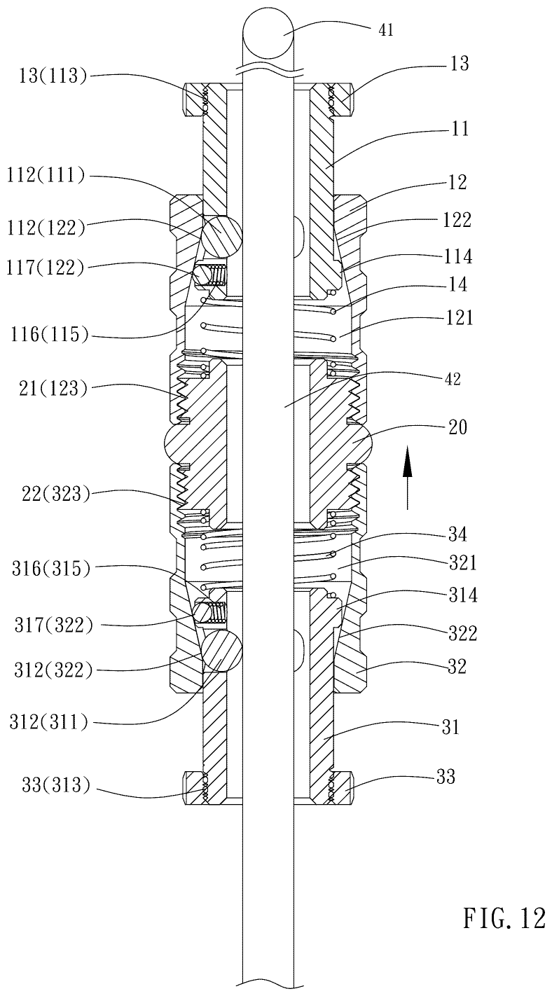

Referring to FIG. 12 with reference to FIG. 11, after the lower coupling member 33 of the lower control module 30 is released, the lower control member 31 is returned by the restoring force of the lower elastic member 34, so that the lower locking members 312 are pressed between the lower conic face 322 of the lower mounting member 32 and the shank 42 of the T-shaped wrench 40, and the grip assembly is positioned on the shank 42 of the T-shaped wrench 40. Thus, the grip assembly is freely moved upward and downward on the shank 42 of the T-shaped wrench 40 so that the position of the grip assembly is adjusted in a stepless manner.

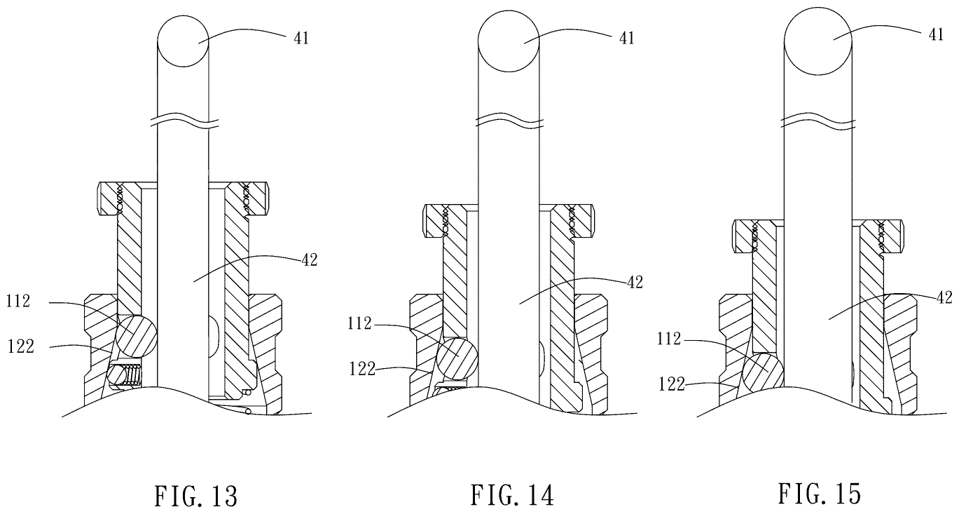

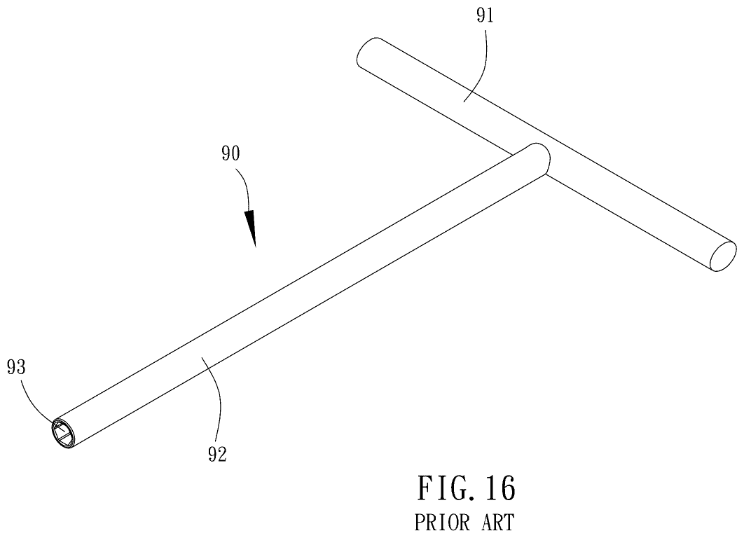

Referring to FIGS. 13-15, the relative position between the upper locking members 112 and the upper conic face 122 (or the lower locking members 312 and the lower conic face 322) is adjusted so that the grip assembly is adapted to fit the shanks 42 of different diameter. Thus, the grip assembly is available for the T-shaped wrench 40 of different sizes.

Accordingly, the grip assembly is held by the user and allows a quick rotation of the T-shaped wrench 40. In addition, the grip assembly is moved upward and downward on the shank 42 of the T-shaped wrench 40 by operation of the upper control module 10 and the lower control module 30, so that the position of the grip assembly on the shank 42 of the T-shaped wrench 40 is adjusted freely in a stepless manner. Further, the relative position between the upper locking members 112 and the upper conic face 122 (or the lower locking members 312 and the lower conic face 322) is adjusted by restriction of the upper control module 10 and the lower control module 30, so that the grip assembly is adapted to fit the shanks 42 of different diameter and is available for the T-shaped wrench 40 of different sizes.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A grip assembly comprising:
an upper control module;
a connecting member connected with the upper control module; and
a lower control unit connected with the connecting member;
wherein:
the lower control unit is arranged opposite to the upper control module;
the upper control module includes an upper control member provided with multiple upper ball holes and multiple upper receiving holes, multiple upper locking members mounted in the upper ball holes, multiple upper springs mounted in the upper receiving holes, multiple upper retaining members mounted in the upper receiving holes, an upper mounting member mounted on the upper control member, an upper coupling member mounted on the upper control member, and an upper elastic member mounted in the upper mounting member;
the upper control member has a tubular shape;
the upper control member has a first end provided with an upper coupling portion and a second end provided with an upper end portion having a larger diameter;
the upper receiving holes are formed in the upper end portion;
the upper mounting member has a cylindrical shape and allows a user's hand holding;
the upper mounting member has an interior provided with an upper receiving portion mounted on the upper control member;
the upper receiving portion has a first end provided with an upper conic face and a second end provided with an upper internal threaded section;
the connecting member has a first end provided with an upper external threaded section and a second end provided with a lower external threaded section;
the upper internal threaded section of the upper mounting member is screwed onto the upper external threaded section of the connecting member;
the lower control module includes a lower control member provided with multiple lower ball holes and multiple lower receiving holes, multiple lower locking members mounted in the lower ball holes, multiple lower springs mounted in the lower receiving holes, multiple lower retaining members mounted in the lower receiving holes, a lower mounting member mounted on the lower control member, a lower coupling member mounted on the lower control member, and a lower elastic member mounted in the lower mounting member;
the lower control member has a tubular shape;
the lower control member has a first end provided with a lower coupling portion and a second end provided with a lower end portion having a larger diameter;
the lower receiving holes are formed in the lower end portion;
the lower mounting member has a cylindrical shape and allows the user's hand holding;
the lower mounting member has an interior provided with a lower receiving portion mounted on the lower control member;
the lower receiving portion has a first end provided with a lower conic face and a second end provided with a lower internal threaded section; and
the lower internal threaded section of the lower mounting member is screwed onto the lower external threaded section of the connecting member.

2. The grip assembly as claimed in claim 1, wherein:
the upper control member is provided with three upper ball holes arranged annularly;
each of the upper ball holes penetrates the upper control member, has a tapered shape, and expands outward;
each of the upper locking members is a ball;
the upper locking members have a number equal to that of the upper ball holes; and
the upper control module includes three upper locking members.

3. The grip assembly as claimed in claim 1, wherein:
the upper coupling portion of the upper control member is an external thread; and
the upper coupling member has a circular shape and has an internal thread screwed onto the upper coupling portion of the upper control member.

4. The grip assembly as claimed in claim 1, wherein the upper control member is provided with three upper receiving holes arranged annularly.

5. The grip assembly as claimed in claim 1, wherein the upper elastic member has a first end pressing the upper end portion of the upper control member and a second end pressing the connecting member.

6. The grip assembly as claimed in claim 1, wherein:
the lower control member is provided with three lower ball holes arranged annularly;
each of the lower ball holes penetrates the lower control member, has a tapered shape, and expands outward;
each of the lower locking members is a ball;
the lower locking members have a number equal to that of the lower ball holes; and
the lower control module includes three lower locking members.

7. The grip assembly as claimed in claim 1, wherein:
the lower coupling portion of the lower control member is an external thread; and
the lower coupling member has a circular shape and has an internal thread screwed onto the lower coupling portion of the lower control member.

8. The grip assembly as claimed in claim 1, wherein the lower control member is provided with three lower receiving holes arranged annularly.

9. The grip assembly as claimed in claim 1, wherein the lower elastic member has a first end pressing the lower end portion of the lower control member and a second end pressing the connecting member.

10. The grip assembly as claimed in claim 1, wherein:
the connecting member has a tubular shape;
the upper elastic member is mounted in the upper receiving portion of the upper mounting member and biased between the upper control member and the connecting member; and
the lower elastic member is mounted in the lower receiving portion of the lower mounting member and biased between the lower control member and the connecting member.
